(19) United States
(12) Patent Application Publication
(10) Pub. No.: US 2008/0080916 A1
(43) Pub. Date: Apr. 3, 2008

(54) Transport apparatus and image-forming apparatus

(75) Inventors: Akira Numazaki, Kanagawa (JP); Kazuo Takano, Kanagawa (JP); Osamu Uto, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/798,721

(22) Filed: May 16, 2007

(30) Foreign Application Priority Data
Oct. 3, 2006 (JP) P2006-271631

(51) Int. Cl. G03G 15/00

(52) U.S. Cl. 399/379; 399/388

(57) ABSTRACT

A transport apparatus includes a transport unit that includes a transport path through which a transported material is transported; and a positioning-and-holding unit that includes a positioning-and-holding member that positions constituents of the transport apparatus to each other and supports the constituents, and a plate-shaped member that works as a part of the transport path and is detachably connected with the positioning-and-holding member.

### CROSS-REFERENCE TO RELATED APPLICATIONS

This application is based on and claims priority under 35 USC 119 from Japanese Patent Application No. 2006-271631 filed on Oct. 3, 2006.

### BACKGROUND

The present invention relates to a transport apparatus and an image-forming apparatus.

### SUMMARY

According to an aspect of the invention, there is provided a transport apparatus including a transport unit that includes a transport path through which a transported material is transported; and a positioning-and-holding unit that includes a positioning-and-holding member that positions constituents of the transport apparatus to each other and supports the constituents, and a plate-shaped member that works as a part of the transport path and is detachably connected with the positioning-and-holding member.

### BRIEF DESCRIPTION OF THE DRAWINGS

FIG. 1 is a diagram showing an image-forming apparatus of an exemplary embodiment of the invention;

FIG. 2 is a perspective view showing a supporting member of the image-forming apparatus of the exemplary embodiment;

FIGS. 3(a), 3(b) and 3(c) are diagrams showing a bottom plate of the supporting member of the image-forming apparatus of the exemplary embodiment; and

FIG. 4 is a perspective view showing the supporting member of the image-forming apparatus of the exemplary embodiment,

wherein 100 denotes an image-forming apparatus; 2 denotes an image output unit; 7 denotes a reverse-transport unit; 8 denotes a supporting member; 60 denotes a reverse-transport path; and P denotes a sheet (recording medium).

### DETAILED DESCRIPTION

Hereinafter, an exemplary embodiment of the invention will be described by reference to the accompanying drawings.

### Exemplary Embodiment

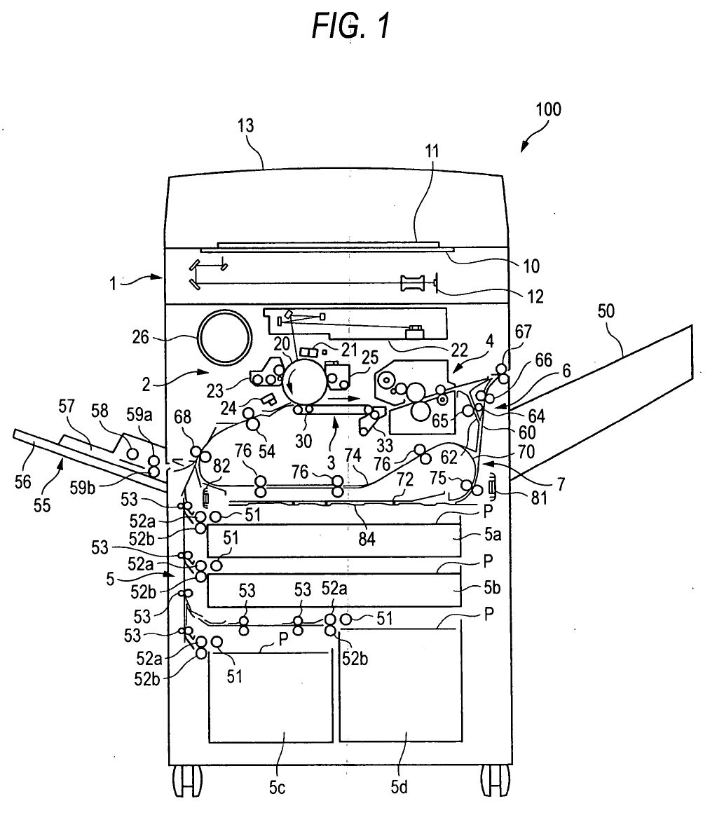

FIGS. 1 to 4 are diagrams which show an exemplary embodiment of an image-forming apparatus according to the invention.

FIG. 1 is a diagram showing an image-forming apparatus 100 in this exemplary embodiment. The image-forming apparatus 100 has an image input unit 1 for optically reading image information of a document 11 placed on a platen 10 and converting the image information so read into electrical image data by a CCD sensor 12 and an image output unit 2 for forming an image on a sheet P (a recording medium) based on the image data transferred from the image input unit 1, and furthermore, the image-forming apparatus 100 has an automatic document feeder 13 for automatically feeding a document 11 on to the platen 10.

The image output unit 2 forms a toner image on a light-sensitive material drum 20 based on the image data transferred from the image input unit 1, and thereafter transfers the toner image on to a sheet P so as to form a recorded image on the sheet P. The sheet P on which the toner image is transferred is discharged on to a discharge tray 50 via a fixing unit 4.

In addition, the light-sensitive material drum 20 rotates at a predetermined processing speed in a direction indicated by an arrowed line, and arranged on the periphery of the light-sensitive material drum 20 are a charging corotron 21 for uniformly charging a surface of the light-sensitive material drum 20 up to a predetermined background potential, a laser beam scanner 22 for exposing the light-sensitive material drum 20 with a laser beam which is modulated based on the image data so as to form an electrostatic latent image on the light-sensitive material drum 20, a developing unit 23 for developing the electrostatic latent image on the light-sensitive material drum 20, a pre-transfer processing corotron 24 for removing the potential on the light-sensitive material drum 20 prior to the transfer of the toner image on to the sheet P, and a cleaner 25 for removing residual toner on the light-sensitive material drum 20 after the completion of transfer of the toner image. Note that in the figure, reference numeral 26 denotes a toner cartridge which contains toner that is to be supplied to the developing unit 23.

On the other hand, s transporting belt 3 for transporting a sheet P is wound round a driving roller and a follower roller and rotates in a direction indicated by an arrowed line, and a toner image formed on the light-sensitive material drum 20 is designed to be transferred to a sheet P which is transported thereto by the transporting belt 3. An transporting roller 30 for forming a transfer electric field between the light-sensitive material drum 20 and itself is provided in a position which faces the light-sensitive material drum 20 across the transporting belt 3. In addition, a belt cleaner 33 is provided in a predetermined position along the transporting belt 3 for removing paper dust and/or residual toner from the surface of the transporting belt 3.

In addition, a sheet-feeding unit 5 for feeding a sheet P to the image output unit 2 is provided below the image output unit 2. Four sheet-feeding trays 5a to 5d are equipped in the sheet-feeding unit 5 which store sheets P in different sizes. In addition, in the sheet-feeding unit 5, pick-up rollers 51 for transporting topmost sheets stored in the individual sheet-feeding trays 5a to 5d towards the image output unit 2 are provided in order to transport sheets P to the image output unit 2 a sheet at a time, and feed rollers 52a and retarder rollers 52b are provided downstream of the pick-up rollers 51 in the direction in which sheets P are transported as double-sheet protectors which prevent plural sheets P from being fed in a superposed fashion to the image output unit 2 by the pick-up rollers 51. In addition, plural transporting rollers 53 are provided in the sheet-feeding unit 5 along a transporting path of sheets P extending from the individual sheet-feeding trays 5a to 5d to a toner image-transferring position. Additionally, registration rollers 54 are provided just before the image-transferring position in the sheet-feeding unit 5. The registration rollers 54 transport sheets P transported from the sheet-feeding trays 5a to 5d to the image-transferring position at a predetermined timing which is in synchronism with a writing timing at which an electrostatic latent image is written on to the light-sensitive material drum 20.

In addition, a sheet-feeding device 55 is provided at one side end portion of the image-forming apparatus 100 for feeding sheets P from an exterior portion of the image-forming apparatus 100 into an interior of the image-forming apparatus 100. The sheet-feeding device 55 is made up of a tray 56 on which sheets P are placed and a feeding unit 57 for feeding sheets P placed on the tray 56 into the interior of the image-forming apparatus 100 a sheet at a time. The sheet-feeding unit 57 includes a pick-up roller 58 for transporting a topmost sheet of the sheets P placed on the tray 56 towards the interior of the image-forming apparatus 100, as well as a feed roller 59a and a retarder roller 59b as a double-sheet protector which prevents plural sheets P from being transported in a superposed fashion towards the interior of the image-forming apparatus 100 by the pick-up roller 58, the feed roller 59a and the retarder roller 59b being provided downstream of the pick-up roller 58 in the direction in which sheets P are transported.

In addition, a reverse-discharging unit 6 is disposed between the fixing unit 4 and the discharge tray 50 for reversing a sheet P discharged from the fixing unit 4 so as to be discharged on to the discharge tray 50. A reverse-transport path 60 is formed in the reverse-discharging unit 6. The reverse-discharging path 60 is made up of a primary reverse-discharging path 62 for drawing a sheet P discharged from the fixing unit 4 thereinto and a secondary reverse-discharging path 64 for reversing the transporting direction of the sheet P so drawn in to discharge the sheet P on to the discharge tray 50. Transporting rollers 65 are provided on the primary reverse-discharging path 62. Transporting rollers 66 are provided on the secondary reverse-discharging path 64. In addition, discharging rollers 67 are provided just before the discharge tray 50.

In addition, a reverse-transport unit 7 is disposed below the image output unit 2 and above the sheet-feeding trays 5a to 5d in the sheet-feeding unit 5 for reversing a sheet P on one side of which an image is formed by the image output unit 2 to transport the sheet P so reversed back to the image output unit 2 for an image to be formed on the other side thereof for double-side image formation. A reverse-transport path 70 is formed in the reverse-transport unit 7. The reverse-transport path 70 is made up of a primary reverse-transport path 72 for drawing a sheet P discharged from the fixing unit 4 thereinto and a secondary reverse-transport path 74 for reversing the transporting direction of the sheet P so drawn in to transport the sheet P to the image output unit 2. Transporting rollers 75 are provided on the primary reverse-transport path 72. In addition, transporting rollers 76 are provided on the secondary reverse-transport path 74.

In addition, transporting rollers 68 are provided upstream of the registration rollers 54 in the sheet-feeding unit 5 for transporting sheets P transported from the sheet-feeding trays 5a to 5d, the sheet-feeding device 55 and the reverse-transport unit 7 to the registration roller 54.

Note that the image output unit 2, the transporting belt 3, the fixing unit 4, part of the sheet-feeding unit 5, the reverse-discharging unit 6 and the reverse-transport unit 7 are supported on a supporting member 8 which is a positioning-and-holding unit. In addition, the transporting belt 3; the fixing unit 4, the part of the sheet-feeding unit 5, the reverse-discharging unit 6 and the reverse-transport unit 7 (a drawer unit U) are supported on a sliding rails 81, 82 which are provided slidably relative to the supporting member 8 in such a manner as to be drawn out to the front of the apparatus.

In the image-forming apparatus 100 of the exemplary embodiment which is configured as has been described heretofore, the laser beam scanner 22 exposes the light-sensitive material drum 20 based on image information on a document which is captured by the image input unit 1, and an electrostatic latent image matching the image information is written on to the light-sensitive material drum 20. This electrostatic latent image is developed by the developing unit 23 at a timing which is slightly later than the writing timing. Then, a toner image, which is formed in this way, is transferred on a sheet P which is transported from the registration rollers 54 by the transporting roller 30 at a predetermined timing, and the sheet P on which the unfixed toner image is transferred is discharged on to the discharge tray 50 via the fixing unit 4.

Note that the sheet P, whose unfixed image has been fixed by the fixing unit 4, is transported to the reverse-discharging unit 6 so as to be reversed thereby for discharge on to the discharge tray 50.

In addition, the sheet P, whose unfixed toner image formed on one side thereof has been fixed by the fixing unit 4, is transported to the reverse-transport unit 7 so as to be reversed to be transported back to the image output unit 2 for an image to be formed on the other side thereof for double-side image formation and is then discharged on to the discharge tray 50.

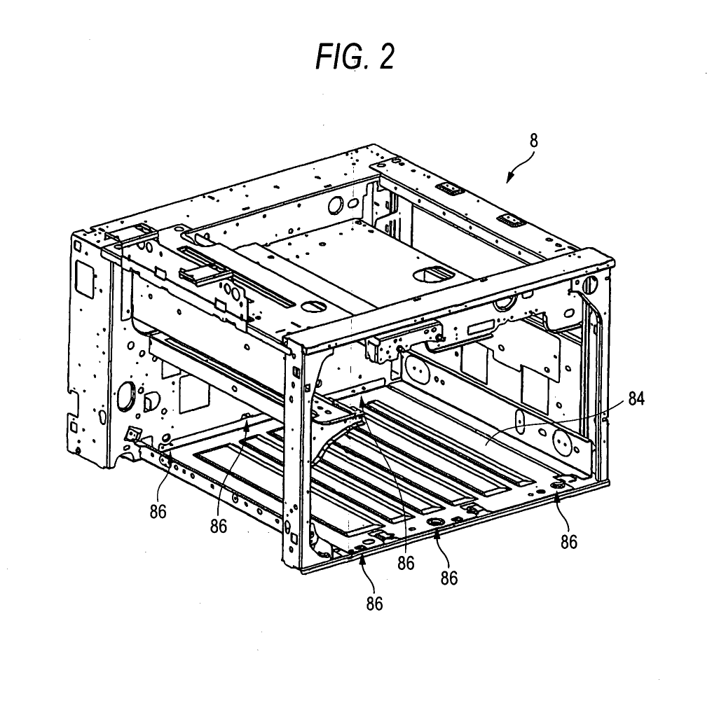

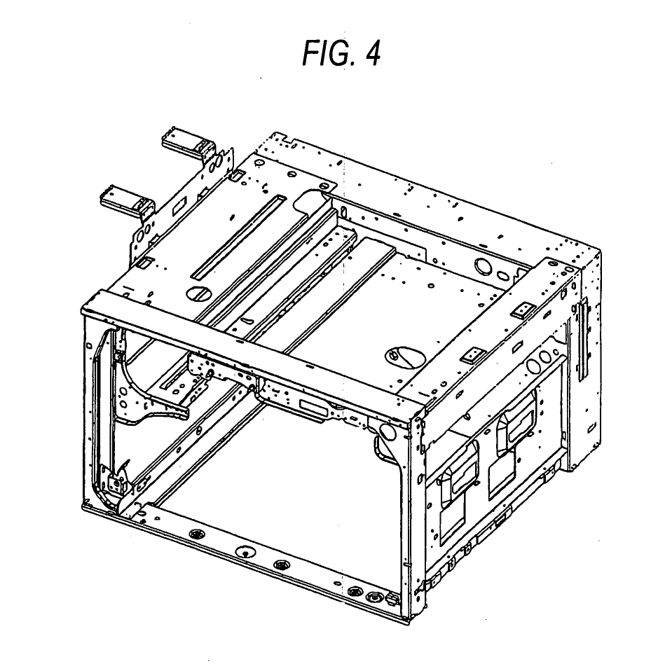

FIG. 2 is a perspective view showing the supporting member 8 of the image-forming apparatus 100 of the exemplary embodiment. In addition, FIG. 4 is a perspective view which shows a state in which a bottom plate 84 is removed from the supporting member 8 of the image-forming apparatus 100 of the exemplary embodiment. The supporting member 8, which is the positioning-and-holding unit, is formed into a box-like shape which is opened at the front thereof, and positions and holds the image output unit 2, the transporting belt 3, the fixing unit 4, the part of the sheet-feeding unit 5, the reverse-discharging unit 6 and the reverse-transport unit 7. The bottom plate 84, which is a plate-shaped member, is provided at a bottom portion of the supporting member 8. The bottom plate 84 of the supporting member 8 constitutes the primary reverse-transport path 72 of the reverse-transport unit 7. The bottom plate 84 is provided detachably relative to the supporting member 8. To be specific, the bottom plate 84 is screwed to the supporting member 8 at plural mounting locations 86 in order to enhance the rigidity of the supporting member 8. Note that the other constituent members which make up the supporting member 8 are welded together.

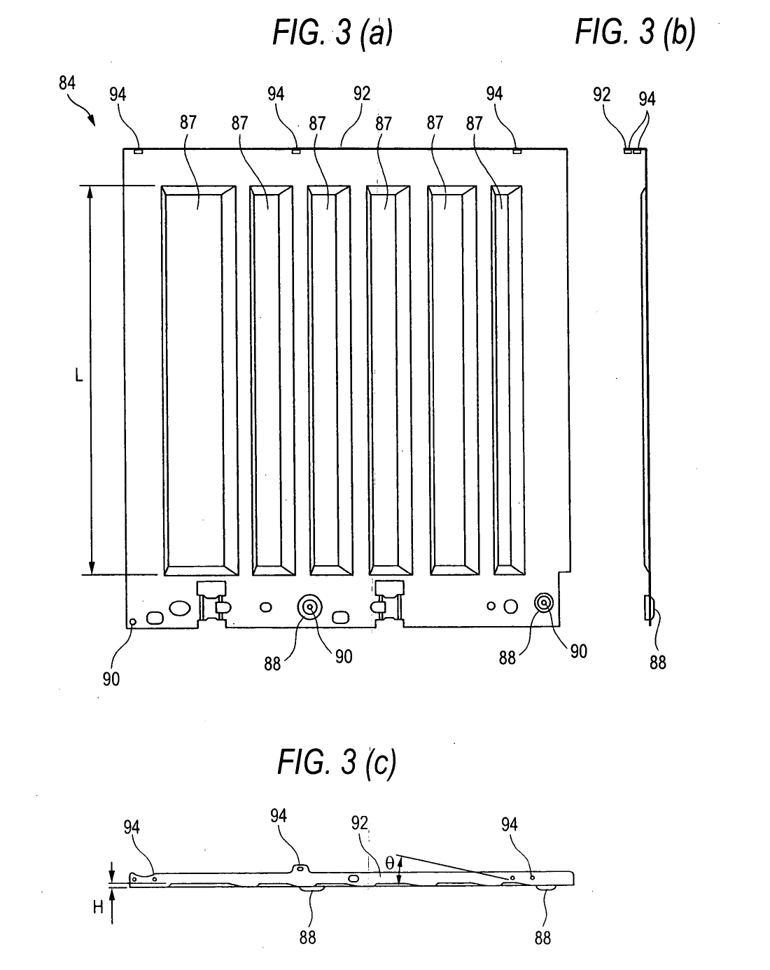

FIG. 3 shows diagrams depicting the bottom plate 84 of the supporting member 8 of the image-forming apparatus 100 of the exemplary embodiment. FIG. 3(a) is a plan view of the bottom plate 84. FIG. 3(b) is a side view of the bottom plate 84. FIG. 3(c) is a front view of the bottom plate 84.

The bottom plate 84 is formed substantially into a rectangular shape. Plural (in this exemplary embodiment, six) protruding portions 87 are formed on the bottom plate 84. The height of the protruding portion 87 is, for example, 2 mm or more and 6 mm or less. The protruding portions 87 are formed in a central portion of the bottom plate 84 which excludes edge portions thereof. The protruding portions 87 are formed in such a manner as to extend in a direction which intersects the direction in which sheets P are transported substantially at right angles. The length L of the protruding portion 87 in a direction in which the protruding portion 87 extends is made longer than the width of a sheet P whose size is the largest in sheets used in the image-forming apparatus 100, the width of the sheet P being defined as extending in a direction which intersects the direction in which sheets are transported substantially at right angles. In addition, the protruding portion 87 is formed in such a manner as to be inclined at a predetermined angle θ from a base portion to an apex portion thereof in a direction in which sheets P enter the primary reverse-transport path 72. The predetermined angle θ is, for example, 10° or more and 20° or less. The protruding portions 87 are formed at predetermined intervals W according to lengths of plural types of sheets P in the direction in which sheets P are transported. The plural type of sheets include, for example, sheets of a size of regular postcards, B5-size sheets, A4-size sheets, B4-size sheets and A3-size sheets. The predetermined interval W is an interval which enables a sheet P to stride across one or more intervals between the protruding portions 87 when the sheet P is drawn into the primary reverse-transport path 72. Circular recessed portions 88 are formed along a front end portion of the bottom plate 84 as viewed from the top. The recessed portions 88 are provided at a central portion and a right-hand side end portion along the front end portion of the bottom plate 84. A hole 90 is formed in a central portion of the recessed portion 88 in such a manner as to allow the pathway of a screw therethrough. Similarly, a hole 90, which allows the pathway of a screw therethrough, is formed in a left-hand side end of the front end portion of the bottom plate. Note that threaded holes, into which screws are screwed, are formed in the mounting portions 86 of the supporting member 8 which coincide in position with the holes 90 in the bottom plate 84. A bent portion 92, which is L-shaped as viewed from the side, is formed at a rear end portion of the bottom plate 84. Threaded holes 94, into which screws are screwed, are formed in a central portion, a right-hand side end portion and a left-hand side end portion of the bent portion 92. Note that holes, into which screws are screwed, are formed in mounting portions 86 of the supporting member 8 which coincide in position with the threaded holes 94 in the bottom plate 84.

Note that the invention is not limited to the exemplary embodiment that has been described heretofore but can be modified variously without departing from the spirit and scope of the invention. For example, while the exemplary embodiment is described as the bottom plate of the supporting member being used as a bottom surface of the reverse-transport path of the reverse-transport unit, a side plate and a top plate of the supporting member can be used as a side surface and a top surface of the reverse-transport path, respectively, or the bottom plate of the supporting member may be used as not part of the reverse-transport unit but as part of a non-reverse-transport unit. In addition, the supporting member does not denote only a member which is related to the whole of the apparatus but includes so-called subframe, unit frame and the like which support some of the constituent components of the apparatus.

While in the exemplary embodiment, as a transport apparatus to which the invention can be applied, the so-called digital copier is raised which installs thereon the image-forming apparatus based on the xerography method, the invention can be applied to image-forming apparatuses which utilize methods other than the xerography such as the ink-jet method, and the invention can also be applied to a printer without an image-forming apparatus. In addition, the invention can also be applied to a sheet-feeding apparatus and a post-processing apparatus which are provided as options to an image-forming apparatus. Moreover, the invention can also widely be applied to not only an image-forming apparatus but also a document feeder for an image reader or a card reader.

What is claimed is:

1. A transport apparatus comprising:
a transport unit that comprises,
a transport path through which a transported material is transported; and
a positioning-and-holding unit that comprises,
a positioning-and-holding member that positions constituents of the transport apparatus to each other and supports the constituents, and
a plate-shaped member that works as a part of the transport path and is detachably connected with the positioning-and-holding member.

2. The transport apparatus according to claim 1,
wherein the plate-shaped member has a surface having protruding portion that protrudes from the plate-shape member to a side of the transported material that passes the transport path.

3. The transport apparatus according to claim 1,
wherein the plate-shaped member is a bottom plate of the positioning-and-holding unit.

4. The transport apparatus according claim 1,
wherein the plate-shaped member is a partition that divides an interior space of the positioning-and-holding unit.

5. An image-forming apparatus comprising:
an image-forming unit;
an image-transferring unit that transfers an image formed by the image-forming unit on a recording medium;
a retransport unit that comprises,
a retransport path through which the recording medium on which the image is transferred by the image-transferring unit is retransported to the image-transferring unit; and
a positioning-and-holding unit that comprises,
a positioning-and-holding member that positions the image-forming unit, the image-transferring unit and the retransport unit to each other and supports the image-forming unit, the image-transferring unit and the retransport unit, and
a plate-shaped member that works as a part of the retransport path and is detachable to the positioning-and-holding member.

6. The image-forming apparatus according to claim 5,
wherein the retransport unit is a reverse-transport unit that reverses the recording medium, on one surface of which the image is formed, and retransports the recording medium to the image-transferring unit; and
the plate-shaped member works as a part of a reverse-transport path in the reverse-transport unit.

7. The image-forming apparatus according to claim 5,
wherein the plate-shaped member has a surface having protruding portion that protrudes from the plate-shaped member to a side of the recording medium that passes the retransport path.

8. The image-forming apparatus according to claim 5,
wherein the plate-shaped member is a bottom plate of the positioning-and-holding unit.

9. The image-forming apparatus according claim 5,
wherein the plate-shaped member is a partition that divides an interior space of the positioning-and-holding unit.

10. A transport apparatus comprising:
a transport unit that comprises a transport path through which a transported material is transported; and
a positioning-and-holding unit that comprises,
a positioning-and-holding member that positions constituents of the transport apparatus to each other and supports the constituents,
a plate-shaped member that works as a part of the transport path, and
a setting unit that detachably fixes the palate-shaped member to the positioning-and-holding member.
